(19) United States
(12) Patent Application Publication
(10) Pub. No.: US 2013/0217284 A1
(43) Pub. Date: Aug. 22, 2013

(54) IRREVERSIBLY PERMEATING FABRIC

(71) Applicant: Chieh-Kun WANG, Taoyuan County (TW)

(72) Inventor: Chieh-Kun WANG, Taoyuan County (TW)

(73) Assignee: SHINETEX ENTERPRISE CO., LTD., New Taipei City (TW)

(21) Appl. No.: 13/481,855

(22) Filed: May 27, 2012

(30) Foreign Application Priority Data
Feb. 20, 2012 (TW) 101203042

(51) Int. Cl. B32B 5/02

(52) U.S. Cl. 442/76

(57) ABSTRACT

An irreversibly permeating fabric that comprises a fabric and an irreversibly permeating layer is disclosed. The fabric is woven with a plurality of fibers and then applied processes to make it moisture-absorbing. The fabric has a first surface and an opposite second surface, wherein the irreversibly permeating layer is inlaid over and beneath the first surface and is in no contact with the second surface. The moisture of the first surface is led unidirectionally and irreversibly to the second surface by the irreversibly permeating layer.

### RELATED APPLICATIONS

The application claims priority to Taiwan Application Serial Number 101203042, filed Feb. 20, 2012, which is herein incorporated by reference.

### BACKGROUND

1. Technical Field

The present disclosure relates to a fabric. More particularly, the present disclosure relates to a clothing fabric which has a moisture management property.

2. Description of Related Art

With the improvement of quality of life, the coziness of cloth wearing is getting more and more attention. The moisture management property is therefore becoming one of the essential functions of a clothing fabric.

During perspiring, the fabric absorbs sweat from the skin and spreads it all over the fabric. The wet fabric makes people feel sticky and uncomfortable.

In order to solve the foregoing problems, one kind of double-layer fabric, which is composed of an inner layer and an outer layer, has been manufactured in the art. The inner layer woven by hydrophobic fibers contacts the skin, and the outer layer woven by hydrophilic fibers exposes to the air. The outer layer of the fabric absorbs the sweat, and the inner layer keeps the sweat into the outer layer for keeping the people from sticky and uncomfortable feeling. This kind of double-layer fabric performs good and permanent moisture management property. However, in this fabric, the two different kinds of fibers have different heat shrinkage rates, and thus need different dyeing and finishing processes. Consequently, it is required a complicated and costly manufacturing process for producing the double-layer fabric.

To overcome the aforementioned problems, another kind of clothing fabric is provided by the manufacturers. Chemicals with water-repellent function are coated in patterns on the inner surface of the clothing fabric. Thus, on the inner surface, the pattern-coated part keeps the sweat from the skin and the other part (i.e. uncoated part) can still absorb the sweat from the skin. In this regard, the clothing fabric seems to provide an improved moisture management property with a simpler and cheaper manufacturing process. However, since only the pattern-coated part of the inner surface has water-repellent property, the uncoated part of the inner surface still causes unpleasant feeling after absorbing sweat from the skin. Hence, such fabric performs a poor and unacceptable moisture management property.

### SUMMARY

According to one embodiment of the present disclosure, an irreversibly permeating fabric is provided. The irreversibly permeating fabric includes a fabric and an irreversibly permeating layer. The fabric is woven with a plurality of fibers and then applied processes to make it moisture-absorbing. The fabric has a first surface and a second surface opposite to the first surface, wherein the irreversibly permeating layer is inlaid over and beneath the first surface and in no contact with the second surface. The moisture absorbed by the first surface is led to unidirectionally permeate to the second surface by the irreversibly permeating layer.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a cross-sectional view of an irreversibly permeating fabric according to one embodiment of the present disclosure; and

FIG. 2 is a schematic view of the irreversibly permeating fabric of FIG. 1 in a wearing mode.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

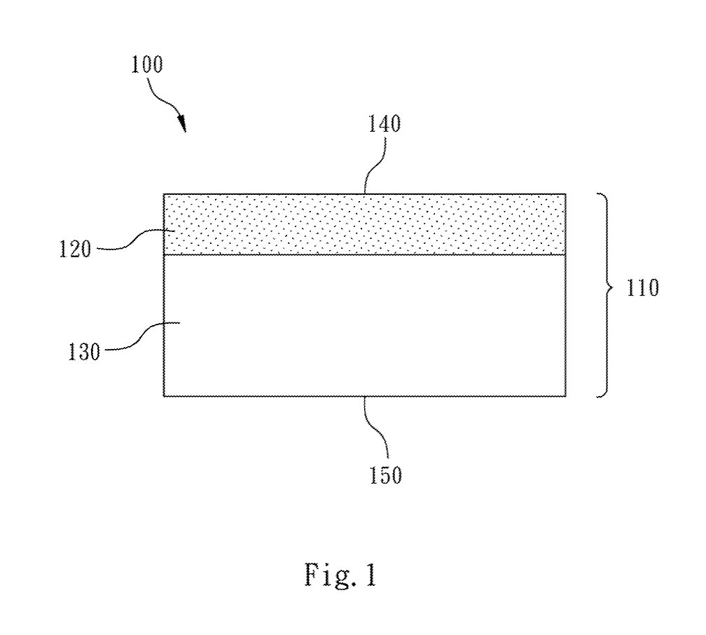

FIG. 1 is a cross-sectional view of an irreversibly permeating fabric 100 according to one embodiment of the present disclosure.

The irreversibly permeating fabric 100 includes a fabric 110 and an irreversibly permeating layer 120. The fabric 110 is woven with a plurality of fibers and then applied processes to make it possess moisture management property (e.g., moisture-absorbing property). The fibers can be natural, synthetic or blend synthetic fibers. The natural fibers are but not limited to cotton, hemp, wool or silk; the synthetic fibers are but not limited to tetoron, nylon, polypropylene, polyethylene, rayon, or recycled cotton. All fibers that can be used to weave clothing fabrics are also suitable for the irreversibly permeating fabric 100 according to the embodiments of the present disclosure. It deserves to be mentioned that the fabric 110 made of the foregoing fibers should be further dyed and processed to possess the moisture-absorbing property. Any process in the art to make the fabric 110 moisture-absorbing is selectable and thus is not repeated here in detail.

The fabric 110 has a first surface 140 and a second surface 150 opposite to the first surface 140. The irreversibly permeating layer 120 is inlaid over and beneath the first surface 140, as shown in FIG. 1, and is not in contact with the second surface 150. In one embodiment of the present disclosure, the irreversibly permeating layer 120 is formed from a mixture of agents with similar properties. The mixture of agents is printed completely over the first surface 140 by using a printing press. The mixture of agents permeates from the first surface 140 into the fabric 110 and clings to part of the fibers, and then a heating process is applied to make the mixture of agents dry, so as to form the irreversibly permeating layer 120 inlaid over and beneath the first surface 140. The irreversibly permeating layer 120 is completely inlaid over and beneath the first surface 140 and thus free of patterns. A moisture-absorbing layer 130 is the part of the fabric 110 not combined with the mixture of agents. The moisture absorbed by the first surface 140 is led unidirectionally and irreversibly by the irreversibly permeating layer 120 to the moisture-absorbing layer 130, and then evaporates to the air through the second surface 150.

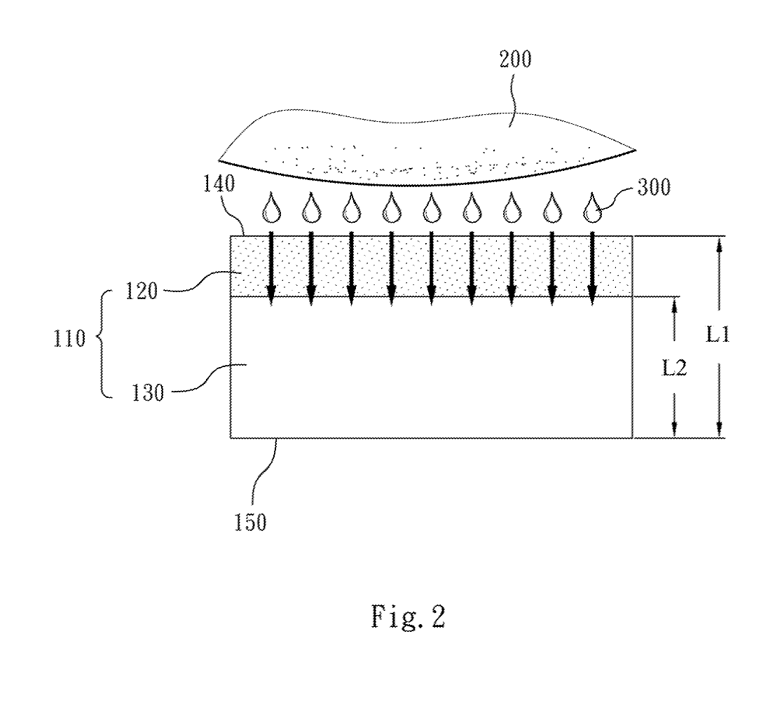

FIG. 2 is a schematic view of the irreversibly permeating fabric 100 of FIG. 1 in using. When a person wears clothes made of the irreversibly permeating fabric 100, the first surface 140 contacts the skin 200 of the person, and the second surface 150 exposes to the air. The moisture 300 (e.g., sweat) from the person is absorbed by the siphon action into the irreversibly permeating layer 120 through the first surface 140. Because the moisture 300 moves unidirectionally and irreversibly in the Irreversibly permeating layer 120, along with the moisture-absorbing property of the fabric 110, the moisture 300 is rapidly led along the direction of the arrows to the moisture-absorbing layer 130, and eventually evaporates into the air through the second surface 150.

Referring to FIG. 2, the fabric 110 has a thickness L1 and the moisture-absorbing layer 130 has a thickness L2. Compare with the fabric 110 with the irreversibly permeating layer 120, a fabric without the irreversibly permeating layer 120 absorbs the same volume as the moisture 300 is spreading the entire fabric with the thickness L1, and the fabric 110 with the irreversibly permeating layer 120 absorbs the whole volume of the moisture 300 and quickly spreads the volume into the moisture-absorbing layer 130 with the thickness L2. The same volume with the smaller thickness L2 means that the moisture 300 diffuses into a larger area on the second surface 150 than the fabric without the irreversibly permeating layer 120. In this regard, the irreversibly permeating fabric 100 has a better moisture management property than the fabric without the irreversibly permeating layer 120.

Furthermore, the moving direction of the moisture in the irreversibly permeating layer 120 is unidirectional and irreversible, such that the moisture in the air or on the second surface 150 has no way to permeate through the irreversibly permeating layer 120 and back to the first surface 140 in contact with the skin 200 of the person. As a result, the person feels cozy with the skin 200 of constantly dry surface 140.

According to the irreversibly permeating fabric provided . by the embodiments of the present disclosure, in that the fabric is made of single kind of fibers, the shortcomings of the fabric woven by two different kinds of fibers are overcome. Further, the first surface completely inlaid with the irreversibly permeating layer exhibits moisture management property superior to that of the conventional fabrics with the water-repellent pattern-coated part. As a result, the manufacturing process is simplified and production cost is reduced.

It will be apparent to those ordinarily skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An irreversibly permeating fabric, comprising:
a fabric woven with a plurality of fibers and having a moisture-absorbing property, wherein the fabric has a first surface and a second surface opposite to the first surface; and
an irreversibly permeating layer, which is inlaid over and beneath the first surface and in no contact with the second surface, for leading the moisture absorbed by the first surface to unidirectionally permeate to the second surface.

2. The irreversibly permeating fabric of claim 1, wherein the irreversibly permeating layer is inlaid completely over and beneath the first surface without patterns.

3. The irreversibly permeating fabric of claim 1, wherein the fibers of the fabric are natural fibers, synthetic fibers, or blend synthetic fibers.

4. The irreversibly permeating fabric of claim 3, wherein the natural fibers are cotton, hemp, wool or silk.

5. The irreversibly permeating fabric of claim 3, wherein the synthetic fibers are tetoron, nylon, polypropylene, polyethylene, rayon, or recycled cotton.

6. The irreversibly permeating fabric of claim 1, wherein the irreversibly permeating layer is printed on the first surface and then permeated, dried and inlaid over and beneath the first surface.
